(19) United States
(12) Patent Application Publication
(10) Pub. No.: US 2020/0102808 A1
(43) Pub. Date: Apr. 2, 2020

(54) PRODUCTION STRING VALVE WITH MULTISEAL SHUTTLE

(71) Applicant: Production Tool Solution, Inc, Acton, CA (US)

(72) Inventors: Lawrence Osborne, Acton, CA (US); Joshua Terry Prather, Acton, CA (US)

(21) Appl. No.: 16/699,581

(22) Filed: Nov. 30, 2019

Related U.S. Application Data
(63) Continuation-in-part of application No. 16/383,517, filed on Apr. 12, 2019.
Application No. 16/383,517 is a continuation of application No. 13/746,279, filed on Jan. 21, 2013, now Pat. No. 10,273,779.
Application No. 13/746,279 is a division of application No. 12/766,141, filed on Apr. 23, 2010, now Pat. No. 8,545,190.

(51) Int. Cl. E21B 34/08; E21B 43/12; F16K 17/04; F16K 17/196

(52) U.S. Cl. CPC E21B 34/08; E21B 43/121; F16K 17/0406; Y10T 137/2544; F16K 17/196; Y10T 137/2557; F16K 17/0473

(57) ABSTRACT

An oilfield production string portion including a valve with a valve housing, a multiseal shuttle including a piston and a lid, the piston having a through hole and movable in the housing for enabling linear flow through the valve or for enabling non-linear flow through the valve.

### PRIORITY CLAIM & INCORPORATION BY REFERENCE

This application, entitled Production String Valve With Multiseal Shuttle, is a continuation-in-part of U.S. patent Ser. No. 16/383,517 filed Apr. 12, 2019 which is a continuation of Ser. No. 13/746,279 filed Jan. 21, 2013 now U.S. Pat. No. 10,273,779 which is a divisional of Ser. No. 12/766,141 filed Apr. 23, 2010 now U.S. Pat. No. 8,545,190. All of these applications are incorporated herein by reference for all intents and purposes.

### BACKGROUND OF THE INVENTION

### Field of the Invention

The present invention relates to a production string valve. In particular, the valve includes a multiseal shuttle.

### Discussion of the Related Art

Pumps and valves located in hard to reach places such as downhole production strings present maintenance and maintenance downtime issues. Where pumps and valves are used to produce a natural resource such as a hydrocarbon, downtime can result in lost production and increased expenses for workmen, equipment, and materials.

In particular, downhole production strings including pumps and valves for lifting fluids such as particulate laden liquids and slurries present a maintenance problem. Here, both pumps and valves can lose capacity and in cases be rendered inoperative when conditions including fluid conditions and fluid velocities fall outside an intended operating range. Such unintended operating conditions can foul, plug, and damage equipment.

Despite the industry's resistance to change, there remains a need to improve production strings.

### SUMMARY OF THE INVENTION

The present invention includes an oilfield production string portion valve with a multiseal shuttle.

In an embodiment, an oilfield production string portion comprises: a valve including a shuttle; the shuttle including a piston and a lid; a piston through hole for providing an oil flow path; the piston extending between a piston mouth and a piston exit; the piston exit having a converging bore and a diverging circumference; to block a first flow through the piston, the lid guided along a piston centerline for mating with the converging bore; and, to block a second flow around a piston exterior and to isolate debris, the diverging circumference for mating with a valve annular lip and forming a closed pocket therebetween.

In some embodiments, the oilfield production portion further comprises: a rod with a first end fixed to the lid; a rod second end with a fastener; the rod movable in a guide fixed in the piston through hole; when the first flow through the piston is blocked, the fastener and the guide exchange no forces; and, when the second flow around the piston exterior is blocked, the fastener and the guide exchange forces.

### BRIEF DESCRIPTION OF THE DRAWINGS

The present invention is described with reference to the accompanying figures. These figures, incorporated herein and forming part of the specification, illustrate the invention and, together with the description, further serve to explain its principles enabling a person skilled in the relevant art to make and use the invention.

FIG. 1 is a schematic diagram of a production string including a valve and a pump for pumping oil in a production string.

FIG. 2 is a diagram of a valve and a pump in a production string with a surrounding casing.

FIGS. 3A-B show a shuttle piston and a shuttle lid for use in the valve of FIG. 1, the shuttle piston movable in a valve housing and the shuttle lid movable with respect to the shuttle piston.

FIGS. 4A-C show lids for use in the valve of FIG. 1.

FIGS. 4D-E show a shuttle piston for use in the valve of FIG. 1.

FIGS. 4F-I show a shuttle piston and lid assembly for use in the valve of FIG. 1.

FIG. 4J shows a lower end view of a shuttle piston with a lid guide inserted in the shuttle piston through hole, the parts for use in the valve of FIG. 1.

FIG. 4K shows an upper end portion of a shuttle piston that includes a shuttle nose in which circumferential pockets are located, the parts for use in the valve of FIG. 1.

FIGS. 5A-B show a shuttle assembly located in a valve body, the parts for use in the valve of FIG. 1.

### DETAILED DESCRIPTION OF THE PREFERRED EMBODIMENTS

The disclosure provided in the following pages describes examples of some embodiments of the invention. The designs, figures, and description are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed invention.

To the extent parts, components and functions of the described invention exchange fluids, the associated interconnections and couplings may be direct or indirect unless explicitly described as being limited to one or the other. Notably, indirectly connected parts, components and functions may have interposed devices and/or functions known to persons of ordinary skill in the art.

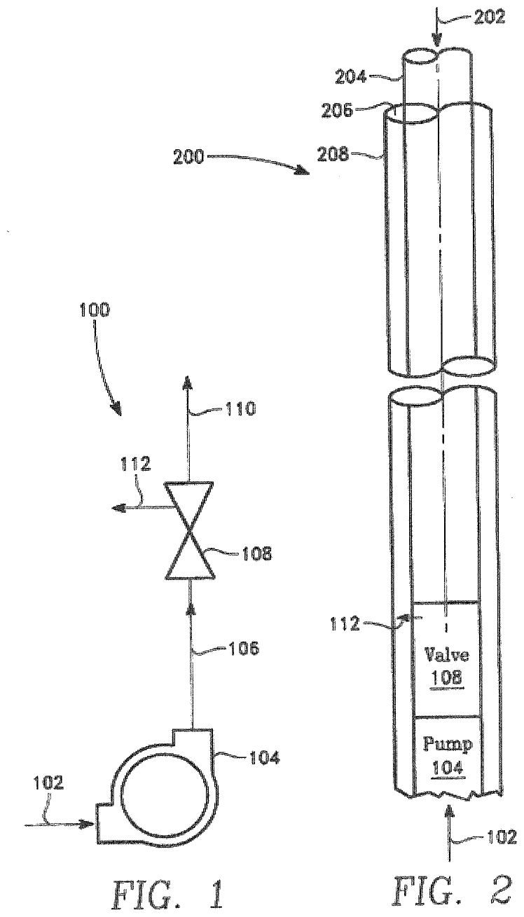

FIG. 1 shows an embodiment of the invention 100 in the form of a schematic diagram. A valve 108 such as a valve with a shuttle is interconnected with a pump 104 via a pump outlet 106. The pump includes a pump inlet 102 and the valve includes a valve outlet 110 and a valve spill port 112. In various embodiments, the inlets, outlets and ports are one or more of a fitting, flange, pipe, or similar parts related to fluid conveyance.

FIG. 2 shows a section of a typical downhole production string 200. The production string includes the valve 108 interposed between the pump 104 and an upper tubing string 204. In some embodiments, a casing 208 surrounds one or more of the tubing string, valve, and pump. Here, an annulus 206 is formed between the tubing string and the casing. A production flow is indicated by an arrow 102 while a backflow is indicated by an arrow 202. In various embodiments, the bypass valve serves to isolate backflows from one or more of the valve, portions of the valve, and the pump.

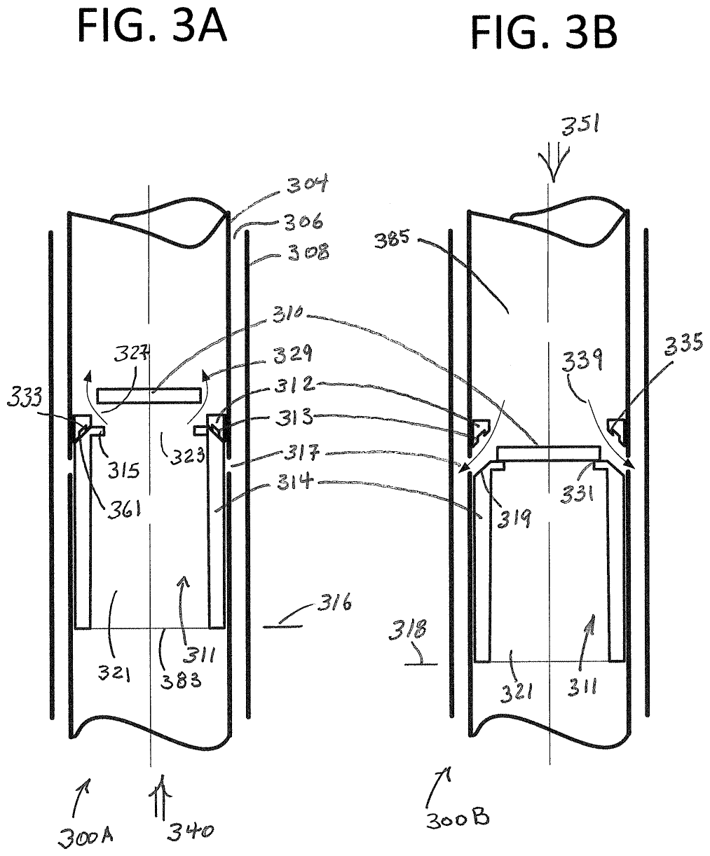

FIG. 3A shows a valve with an elevated piston 300A. A valve shuttle 311 includes a piston 314 and a lid 310. The piston includes a mouth 383 and a through hole 321 with a rim 315 at a through hole exit 323. The rim is for mating with the lid to block flow in the through hole. The shuttle is located in a valve housing 304 and a casing 308 may be around the valve housing to provide an annular space 306 between the valve housing and the casing.

As shown in the figure, the lid 310 is elevated above the piston 314 creating an open piston-lid seal 327 where piston through hole flow leaves the piston 329 via a circumferential space between the piston and the lid. When the piston is elevated 316, the lid may be elevated above the piston and a piston brim 319 at the piston upper end may abut a lip or annular lip 312 extending from the valve housing 304 creating a closed brim-lip seal 361. And, when the piston is elevated, the piston may cover one or more holes or ports 317 in the valve housing. One of or both of the closed brim-lip seal 333 and the piston covering the port may block flow or assist in blocking flow through the port.

In some embodiments, the lip 312 or the brim 319 may have a pocket or a circumferential pocket 313. And in some embodiments, the lip and the brim may have a pocket or a circumferential pocket. Where a pocket is provided, it may enhance the seal, ease separation of the lip and the brim, trap particulate such as particulate carried by the flow 340, provide a space for holding particulate to reduce particulate at the brim-lip sealing surfaces, or otherwise serve to enhance operation of the brim-lip seat

FIG. 3B shows a valve with a lowered piston 300B. As shown, when the piston 314 is lowered 318 the lid 310 may be mated with the piston creating a closed piston-lid seal 331 while the piston brim 319 may be separated from the lip 312 creating an open brim-lip seal 335. And, when the piston is lowered, the piston may move away from or uncover one or more holes or ports 317 in the valve housing. Here, there may be flow or reverse flow 351 into a zone above the piston 385 that continues 339 into the annulus 306 via the port 317. While flow enters the annulus, valve housing flow 340 may be blocked.

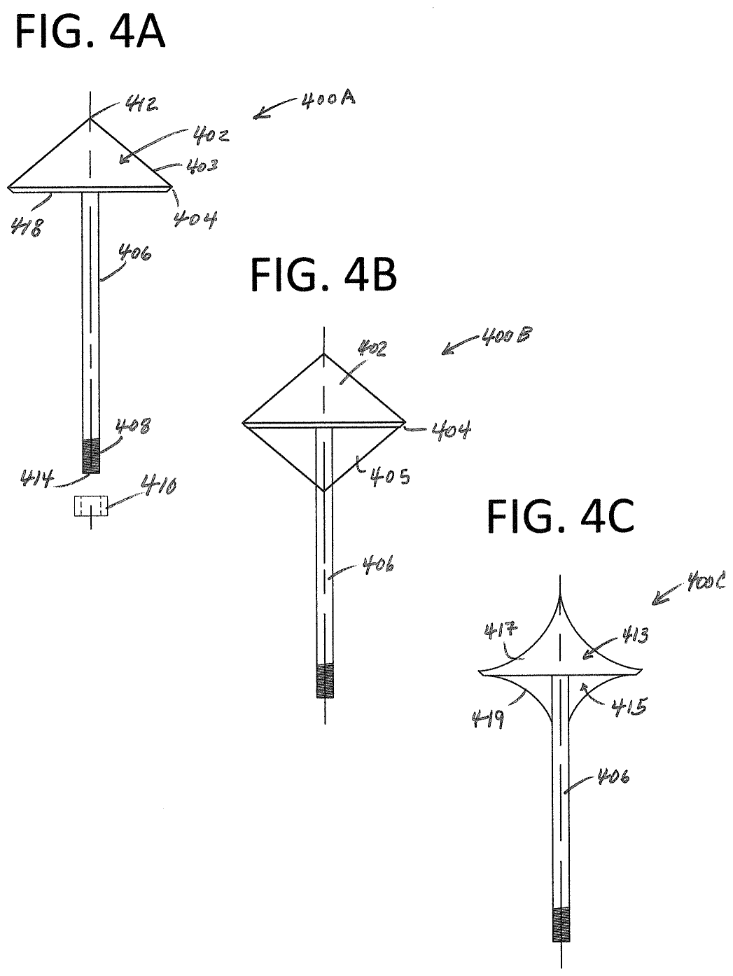

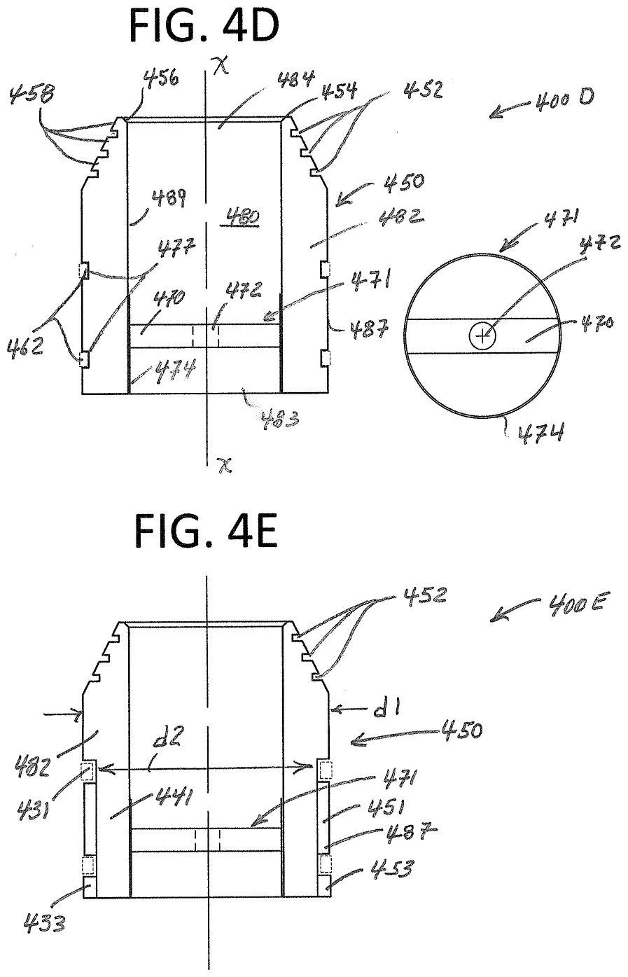

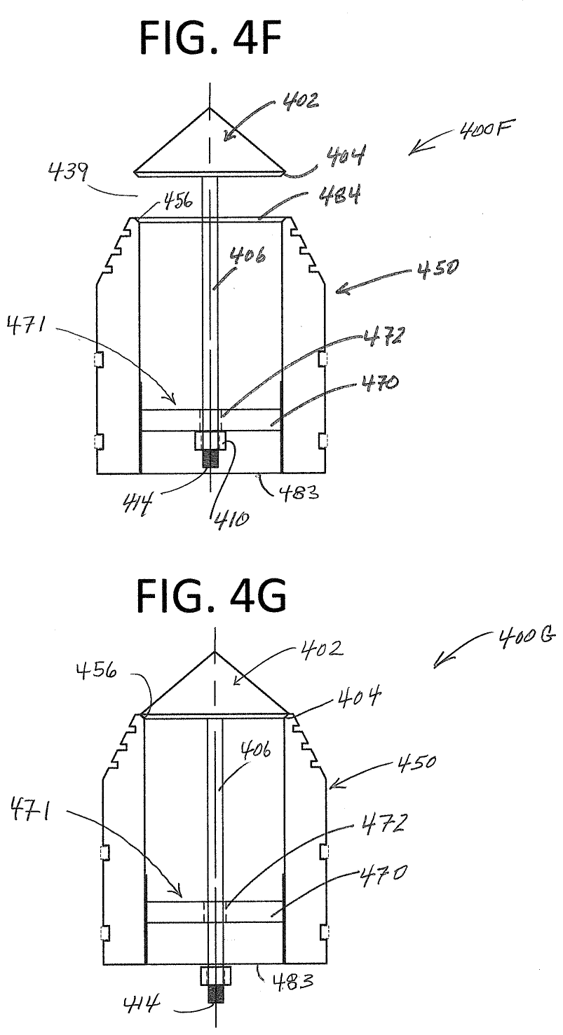

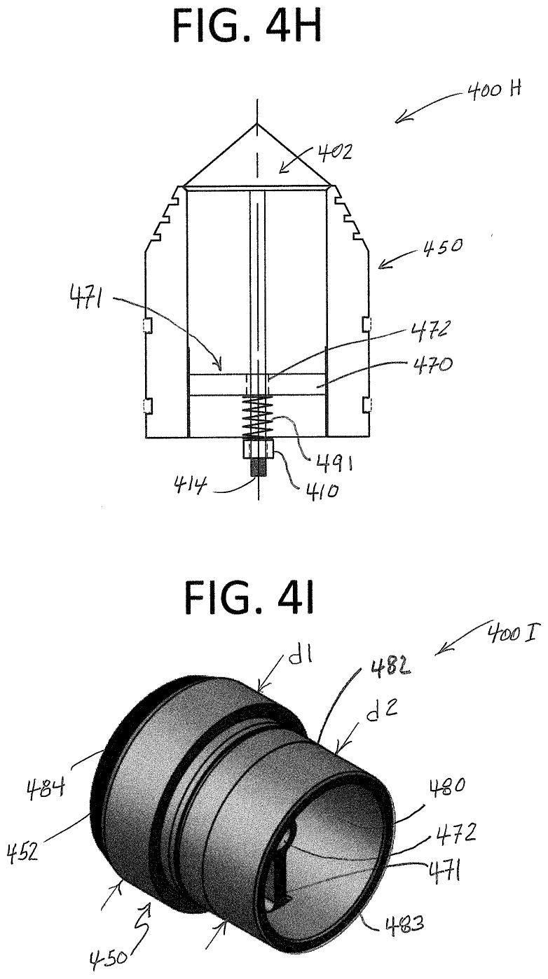

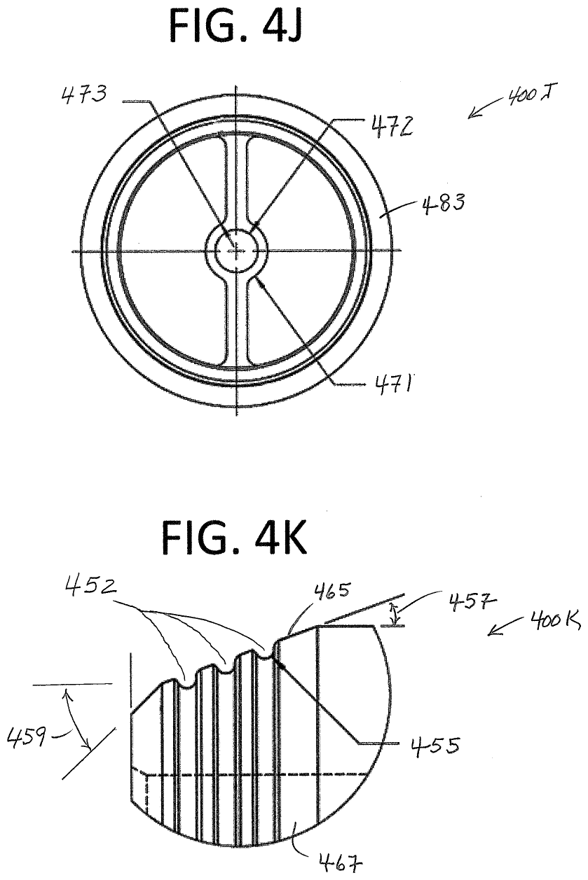

FIGS. 4A-H show shuttle embodiments with a tethered lid 400A-H. FIGS. 4A-C show embodiments of the lid. In FIG. 4A, a rod 406 with a free end 414 extends from a cone shaped lid 402. Threads 408 at the rod free end are for receiving a mating fastener or nut 410.

The lid 402 has an apex or uppermost portion 412 and a base or lowermost portion 418. At the base, a sealing feature such as a circumferential chamfer 404 is for mating with a piston 450. Between the apex and the base is a lid sidewall 403 that may be sloped as shown or otherwise shaped to interconnect the apex and base with a stepped or curved line.

FIG. 4B shows a lid having an upper conical portion 403 and a lower conical portion 405 with a chamfer 404 therebetween. Variations on either of these conical portions may be as described above.

FIG. 4C shows a lid having an upward pointed section 413 with a curved sidewall 417 and a downward pointed section 415 with a curved sidewall 419. Variations on either of these sidewalls may be as described above.

FIGS. 4D-I show embodiments of the shuttle piston 400D-I. FIG. 4D shows a shuttle piston with pockets 452 and a rod guide 471. Here, a piston sidewall 482 encircles a piston through hole 480. At an upper end 454, a piston exit 484 is surrounded by a sidewall chamfer such as a converging bore 456. Opposite the chamfer, the circumference of the piston diverges 458 forming a pointed piston exit end. In various embodiments, one or more circumferential slots or pockets 452 in the diverging circumference are in planes perpendicular to a piston axis x-x. Where there are plural pockets, they may be interconnected or not.

In the piston through hole 480, a rod guide 471 extends between piston sidewalls 489 and provides a centering hole 472 for the lid rod 406. The rod guide may be near a piston inlet end 483. In an embodiment, a hoop 474 is a part of or is inserted in the piston through hole 480. The hoop provides structure for holding a guide cross-member 470 which includes the centering hole.

Opposite the piston exit end the piston inlet end 483 is surrounded by a piston skirt 487. In or near the piston skirt, external piston grooves 477 provide a seat(s) for sealing bands 462 such as plastic, metal, or elastomeric sealing bands.

FIG. 4E shows a piston with piston or skirt rings 400E. As shown, the piston has a first sidewall thickness 482 and diameter d1 and a second lesser sidewall thickness 441 and diameter d2 in the region of the piston skirt 487. Diameter d2 is for receiving seals 462 and piston rings 451, 453. In this assembly, diameter d2 receives a first seal 431 followed by a first piston ring 451, followed by a second seal 433, followed by a second piston ring 453.

FIGS. 4F-H show an assembled shuttle 400F-H. In FIG. 4F, the lid 402 and lid rod 406 are tethered to the rod guide 471 via a fastener affixed at or near the rod free end 414. As shown, the lid is lifted away from the piston 450 such that a circumferential or annular space 439 at the piston exit 484 provides a passage for a flow moving from the piston inlet 483 to the piston exit 484.

In FIG. 4G, the lid 402 and lid rod 406 are tethered to the rod guide 471 via a fastener affixed at or near the rod free end 414. As shown, the lid is closed against the piston 450 such that a lid chamfer 404 is mated with a internal piston exit chamfer 456 to block flow through the piston.

In FIG. 4H, the lid 402 and lid rod 406 are tethered to the rod guide 471 via a fastener affixed at or near the rod free end 414. As shown, the lid is closed against the piston 450. As shown here, some embodiments may include a spring 491 around the rod 406 and between the rod guide 471 and the fastener 410. Where a spring is used, it may urge the lid to close against the piston and require a flow to overcome forces including the spring force in order to lift the lid away from the piston.

FIG. 4I-J show a piston and a rod guide 400I-J. FIG. 4I shows a piston 400I similar to that of FIG. 4E. At a piston exit end 484 pockets or circumferential pockets 452 surround a piston periphery. Near a piston inlet end 483 a lid guide 471 is in or inserted in a piston through hole 480. As mentioned before, pocket(s) 484 may enhance and or protect a brim-lip seal 361 between a piston brim 319 and a valve housing lip 312.

Piston diameters d1 and d2 where d2<d1 provide a piston sidewall 482 step for receiving seals and/or piston rings. The piston rings may be mated with piston sidewall external threads.

FIG. 4J shows the lid guide 471 which fits within the piston through hole 480 having center 473. The lid guide may be located near the piston exit end 484 or near the piston inlet end 483. Notably, the guide center hole 472 through which the rod 406 passes may be lengthened (about 0.25 to 1.25 inches) to provide additional rod guidance. The rod guide may also be moved closer to the piston exit 484 (within about 0.5 to 2.0 inches) to provide additional rod guidance. And where operating or fluid conditions suggest it is beneficial, the rod may be shaped to fit within a rod guide hole having a complementary shape such that the rod does not rotate within the rod guide hole.

FIG. 4K shows pocket details 400K. Here, three pockets 452 on the piston 450 near the exit end 484 are shown. The pockets are in a sloped face 467 near the piston exit described by an angle (between 10 and 40 degrees, in some embodiments about 20 degrees) 457 between a piston sidewall portion 461 and a piston converging portion 465. At the piston exit, the sloping face angle may increase to an angle 459 of about 45 degrees. As shown, the root of the pockets may be curved 455 as shown in FIG. 4K or may be flat or somewhat flat as shown in FIG. 4D.

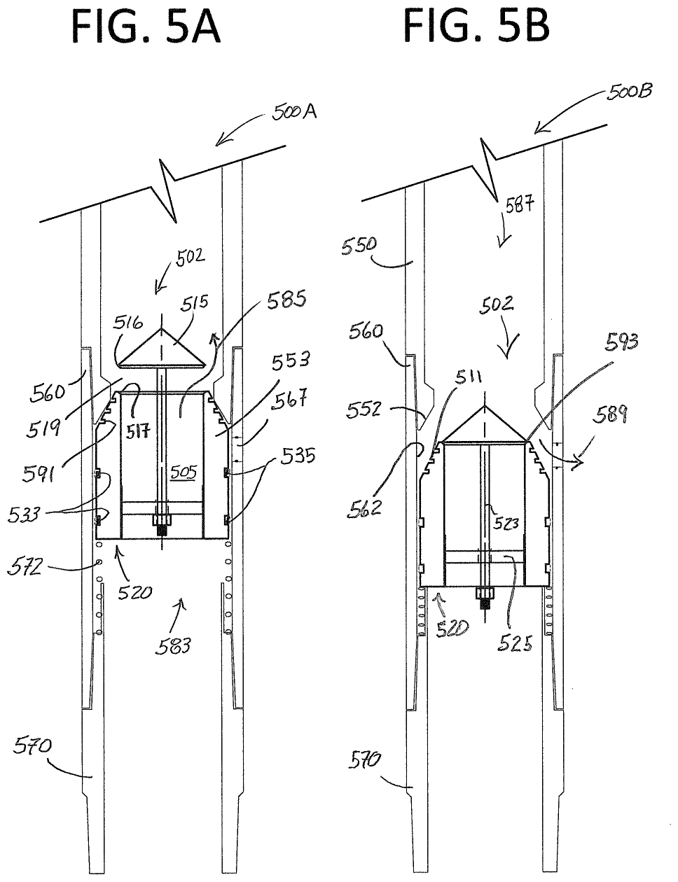

FIGS. 5A-B show a valve installed in a portion of a production string 500A-B. In the figures, a valve shuttle 502 including a piston 520 and a lid 515 is inserted in a valve body 560.

The valve body 560 may adjoin an integral or separate upper flow chamber 550 having a lip 552 for mating with the brim 511 of a piston to create a brim-lip seal 591. And, the valve body may adjoin an integral or separate lower housing 570. In some embodiments, a coil spring urges the piston toward the lip 552, for example a coil spring located between a portion of the lower housing and the piston such that the piston is urged to close the brim-lip seal.

The lid 515 is tethered by a rod 523 that passes through a rod guide 525. The rod guide may be located in the piston through hole 505 allows the lid to move away from the piston and open a piston-lid seal 593 between a lid chamfer 516 and a piston through hole chamfer 517.

A piston 520 sidewall 553 may have external grooves 533 and piston ring seals 535 may be located in these external grooves. These seals may limit or stop flow between the piston 520 and the valve body 562.

In FIG. 5A, the shuttle 502 is elevated, the brim-lip seal 591 is closed, and a port 567 in the valve body may be covered by the piston 520. Flow through the port may be blocked by one of or some combination of the piston sidewall 533, the brim-lip seal 591, and the piston ring seals 535.

As seen, the lid 515 is elevated above the piston 520 opening a flow zone 519 such as a circumferential flow zone or space or area which may be a flow zone around the rod 523. Here, flow from the lower housing 583 may pass via the piston through hole 505 into the zone 519 and into the upper flow chamber 550. Flow through this flow zone 519 is shown by flow arrow 585.

In FIG. 5B, the shuttle 502 is closed against the piston 520. As shown, a lid chamfer 516 my be mated with a piston exit chamfer 517 and a piston-lid seal 591 may be formed. The piston-lid seal blocks flow through the piston such that pressure above the piston a) forces the piston down opening the brim-lid seal 591 and b) moves the piston away from or uncovers the valve body sidewall port 589. The piston may compress the spring 572 as it is forced down. When the shuttle is in this configuration flow from the upper flow chamber 587 may pass through the port.

It should be noted that normal pump 104 operation results in a shuttle configuration as shown in FIG. 5A. Here, production flow from the pump 583 passes between the piston 520 and the lid 515, rises through the upper flow chamber and rises through production tubing to a piping, recovery and/or storage facility.

When pump 104 operation is not normal the pump may stop or its flow 583 may be impeded by debris/contaminants in the flow. This case is shown in FIG. 5B. Here, fluid above the shuttle 587 flows toward the shuttle, pushes the shuttle downward, and opens the valve body sidewall port 589 which empties the flow into annulus 206 which in cases returns the emptied flow to the pump suction 102.

The present invention has been disclosed in the form of exemplary embodiments; however, it should not be limited to these embodiments. Rather, the present invention should be limited only by the claims which follow where the terms of the claims are given the meaning a person of ordinary skill in the art would find them to have.

1. An oilfield production string portion comprising:
a valve including a shuttle;
the shuttle including a piston and a lid;
a piston through hole for providing an oil flow path;
the piston extending between a piston mouth and a piston exit;
the piston exit having a converging bore and a diverging circumference;
to block a first flow through the piston, the lid guided along a piston centerline for mating with the converging bore; and,
to block a second flow around a piston exterior and to isolate debris, the diverging circumference for mating with a valve annular lip and forming a closed pocket therebetween.

2. The oilfield production string portion of claim 1 further comprising:
a rod with a first end fixed to the lid;
a rod second end with a fastener;
the rod movable in a guide fixed in the piston through hole;
when the first flow through the piston is blocked, the fastener and the guide exchange no forces; and,
when the second flow around the piston exterior is blocked, the fastener and the guide exchange forces.

3. The oilfield production string portion of claim 2 wherein:
the pocket includes a groove in the annular lip; and,
the groove is covered by the diverging circumference when the second flow around the piston exterior is blocked.

4. The oilfield production string portion of claim 2 wherein:
the pocket includes a groove in the diverging circumference; and,
the groove is covered by the annular lip when the second flow around the piston exterior is blocked.

5. The oilfield production string portion of claim 4 wherein plural grooves surround the diverging circumference.

6. The oilfield production string portion of claim 5 wherein at least two of the grooves are interconnected.

7. The oilfield production string portion of claim 5 wherein there is no interconnection between grooves.

8. The oilfield production string portion of claim 4 further comprising:
a coil spring encircling the rod; and,
the coil spring located between the fastener and the guide.

9. The oilfield production string portion of claim 4 wherein the rod protrudes from the piston mouth when the first flow is blocked.

10. The oilfield production string portion of claim 4 wherein the rod does not protrude from the piston mouth when the second flow is blocked.
